(19) United States
(12) Patent Application Publication
(10) Pub. No.: US 2006/0173738 A1
(43) Pub. Date: Aug. 3, 2006

(54) Method and system of marketing diamonds

(76) Inventor: Dmitry Marmershteyn, Los Angeles, CA (US)

Correspondence Address: TROJAN LAW OFFICES, 9250 WILSHIRE BLVD, SUITE 325, BEVERLY HILLS, CA, 90212, US

(21) Appl. No.: 11/049,475

(22) Filed: Feb. 2, 2005

(51) Int. Cl. G07G 1/14; G06Q 30/00

(52) U.S. Cl. 705/14

(57) ABSTRACT

A method and system of marketing diamonds that came from a single rough diamond is described. A single rough diamond is cut into at least two smaller diamonds. The smaller diamonds are provided for sale in sets, each set having at least two diamonds. Documentation stating that the diamonds in a set came from a single rough diamond is provided with each diamond set. In another embodiment, the method further comprises packaging a set of the smaller diamonds in one or more jewelry boxes. The diamonds may be loose or mounted onto at least two distinct pieces of jewelry. The consumers buying the sets of diamonds made in accordance with this invention will wear their diamond, knowing that a diamond from the same rough is also worn by their loved one. Thus, the method and system of the invention provide added appeal of diamonds to consumers.

### FIELD OF THE INVENTION

This invention relates generally to a method for marketing diamonds, and more particularly, to a method of marketing diamonds that originate from the same rough diamond.

### BACKGROUND OF THE INVENTION

Sales of diamonds are booming worldwide. Diamonds are bought by consumers in association with many special occasions, and are sold through a variety of marketing methods that appeal to the consumers' romantic or familial feelings.

One such known method is selling a diamond as a single stone. The single or loose diamond can be can be mounted on a ring, creating a solitaire, which is commonly used as an engagement ring. Alternatively, multiple diamonds can be mounted on various pieces of jewelry. Such jewelry can include rings, necklaces, bracelets, pendants, earrings, or the like. The diamonds mounted on such jewelry can be all of varying sizes or all the same size.

According to the principles of nearly all known marketing methods, single diamonds, and jewelry having diamonds, are designed for use by one individual. That individual will either wear the jewelry him or herself, or will give it as a gift to another individual, who will wear the gift him or herself. There are also some known marketing methods where articles of jewelry are marketed for sale in one set to more than one individual. Such methods include, for example, his and her rings, his and her bracelets, his and her watches, and the like.

The above marketing methods all have an inherent disadvantage. Specifically, they all concentrate either on selling an individual diamond, or on selling a complimentary set of jewelry containing diamonds, with the origin of the diamonds used being irrelevant. Equally irrelevant is the inter-relationship between the actual diamonds marketed through such methods. None of these known methods attempt to increase the romantic or familial appeal in the consumer by taking advantage of the fact that certain diamonds came from a single rough diamond and were meant to be together by nature.

Accordingly, there is a need for a method of marketing diamonds that will increase the appeal of diamonds to consumers by marketing sets of diamonds that came from a single rough diamond. This will provide extra incentive to consumers for buying certain diamonds and jewelry as a means of making a statement that just like the diamonds, which were meant to be together by nature, so too are the giver and the recipient of such diamonds.

### SUMMARY OF THE INVENTION

This invention satisfies the above need. According to the invention, there is provided a method of marketing diamonds that came from a single rough diamond. This method of marketing comprises the steps of (a) cutting a single rough diamond into at least two smaller diamonds; (b) providing the smaller diamonds in sets for sale, with each set having at least two diamonds; and (c) including documentation with the set, the documentation specifying that the diamonds in the set came from a single rough diamond.

In one embodiment, the method of marketing further comprises taking a photograph of the single rough diamond prior to cutting the rough diamond into smaller diamonds. The photograph of the rough diamond can be included with the documentation provided with the diamond set.

In another embodiment, the method further comprises packaging a set of the smaller diamonds in one or more jewelry boxes. In yet another embodiment, the method further comprises applying decorative matter onto the jewelry box. In yet another embodiment, the method further comprises applying message-bearing indicia onto the jewelry box.

In yet another embodiment, the method includes the step of providing a display in close proximity to the diamonds being sold in the set. The display states that the diamonds being sold in the set have come from a single rough diamond. Optionally, the display contains a catch phrase that will signify identity of origin, unity or togetherness of the diamonds and of their owners, and is designed to attract the consumers to the diamonds and to entice the consumers to buy the diamonds.

In yet another embodiment, the method of marketing further comprises micro-engraving the smaller diamonds provided in the set with serial numbers. The serial numbers are similar enough to make it clear that the diamonds one set came from a single rough diamond.

In yet another embodiment, the diamonds can be mounted onto at least two distinct pieces of jewelry. Such jewelry could be rings, watches, bracelets, or the like.

According to the method of this invention, loose diamonds that came from a single rough diamond can be marketed and sold in a set, providing added appeal to potential consumers. The consumers buying the sets of diamonds made in accordance to the method of this invention will wear their diamond, knowing that a diamond from the same rough is also worn by their loved one, be it husband/wife, boyfriend/girlfriend, parent/child, brother/sister, or the like.

### DETAILED DESCRIPTION OF THE PREFERRED EMBODIMENT

The following discussion describes in detail several embodiments of the invention and several variations of those embodiments. This discussion should not be construed, however, as limiting the invention to those particular embodiments. Practitioners skilled in the art will recognize numerous other embodiments as well.

The invention is a method for marketing diamonds that came from the same rough diamond. In the method, a single rough diamond is cut into at least two smaller diamonds. The smaller diamonds are polished according to techniques well known in the art. The smaller diamonds are then distributed to diamond and jewelry retailers in sets, with each set having jewelry-mounted diamonds or loose diamonds that came from the same rough diamond.

In the preferred embodiment, documentation is included with the diamonds being marketed according to the invention. The documentation specifies that the diamonds being sold in the set came from a single rough diamond. The documentation may be in the form of a single sheet of paper, or in the form of a booklet. Optionally, the documentation may identify the location of the mine from which the rough diamond was obtained. The documentation is designed to enhance the romantic or familial aspect of the diamond set. For example, the documentation may contain a brief narrative in the form of a romantic story depicting two diamonds or people that were meant to be together by nature.

In another embodiment, the diamond set is packaged in at least one jewelry box. For instance, one diamond set may be entirely packaged within one jewelry box. Alternatively, each individual diamond of a set can be packaged in its own jewelry box. By the same token, jewelry pieces containing the diamonds that came from the same rough diamond can be either packaged in a single jewelry box or in separate jewelry boxes.

In another embodiment of the invention, a photograph is taken of a single rough diamond prior to the cutting of the single rough diamond into several smaller diamonds. In this embodiment, such photograph is provided together with the diamond set marketed according to the invention. The photograph of the rough diamond can be provided either separately from the documentation described above, or can be included in the documentation booklet. The photograph provides added pleasure to the consumer by allowing the consumer to actually observe the original rough diamond that gave rise to the marketed diamond set.

In another embodiment of the invention, decorative matter is applied to the jewelry box containing the diamond set. The application of decorative matter may be done through panting, engraving, embroidery, etching, or the like known techniques. The decorative matter will be applied in such a way as to make the jewelry box aesthetically pleasing and alluring to the consumers.

In yet another embodiment, message-bearing indicia may be applied to the jewelry box using the known techniques. Such indicia may be applied to the outside of the box only, to the inside of the box only, or to both the outside and the inside of the box. Typical such indicia include a catchy phrase or a brand name, which will be designed to indicate that the jewelry inside the box contains diamonds that come from the same origin and are meant to be together. Other indicia may later be applied to the jewelry box to personalize the gift according to consumer needs. For example, the names of the purchaser and the recipient may be added, or personalized messages may be added to the box.

In yet another embodiment, serial numbers may be micro-engraved on the diamonds being sold in the set according to the invention. The diamond micro-engraving techniques are known in the art. Each diamond is engraved with its own unique serial number.

Optionally, the main serial number for all diamonds coming from a single rough diamond will be the same. Additionally, each diamond will have its own unique number or letter separated by a dash from the main serial number. Numbering the diamonds in such a way will allow the retailer and the consumer to not only see which diamonds came from the same rough diamond, but also will allow them to easier identify the individual diamonds in a set.

In yet another embodiment, the single rough diamond is cut into multiple smaller diamonds in such a way as to create matching edges in the smaller diamonds. The diamonds with matching edges can then be sold in a set as a matching pair. The diamonds can be sold as loose diamonds, or can be mounted on distinct pieces of jewelry. The effect of this embodiment would be to create additional appeal to consumers by representing that the two diamonds of a set can be put together to form one diamond by matching up their edges and bringing them together.

In another embodiment of the invention, a display is provided in close proximity to the diamond set. The display can be in the form of an advertisement poster, a price tag or sticker, a postcard, or the like. The display typically states that the diamonds being sold in the set have come from a single rough diamond. The display may also contain catchy or promotional language, designed to increase the enticing effect of the diamonds sold in the set.

The diamonds marketed according to this invention can be sold as loose diamonds, or can be mounted on jewelry pieces. Such jewelry pieces can be, for example, rings, bracelets, watches, pendants, or the like. Preferably, at least two distinct jewelry pieces are used in a set, since the diamonds marketed according to this invention are generally intended for use by two people.

Thus, for example, a jewelry set compatible with the method of the invention could be two rings, with the diamonds in each of those rings coming from the same rough diamond. The two rings may be marketed to romantic couples, such as husbands and wives, boyfriends and girlfriends, and the like. The marketing method of the present invention will provide extra appeal to romantic couples because they will feel a sense of togetherness, unity, or fate since the diamonds they will be wearing came from the same rough diamond, and were intended to remain together in nature.

The rings may also be worn by multiple members of the same family. For example, the older generations may have diamonds of one size, and the younger generations having diamonds of larger or smaller sizes. Alternatively, all members of the family may have diamonds of identical size. The added appeal of diamonds and diamond jewelry added by the invention is that members of the family will feel closeness and unity with one another due to the fact that all of the diamonds on their jewelry came from a single rough diamond.

It is also contemplated that a consumer may buy diamonds or diamond jewelry marketed according to this invention for purely individual use. For example, someone may find it more appealing to wear a ring, bracelet, or a watch that contains only diamonds that came from the same rough diamond.

A system for marketing diamonds according to the method described above is also provided. The system comprises a set of at least two diamonds that came from a single rough diamond and documentation specifying that the diamonds in the set came from a single rough diamond.

The system can optionally include a photograph of the rough diamond, which was cut into multiple diamonds that are included in the set. Also, the system can optionally be packaged and distributed in a jewelry box. The system can optionally include decorative matter on the jewelry box. The system can also optionally include message-bearing indicia thereon, such as personalized engravings, etchings, or the like. Also, the system may optionally include a display in close proximity to the diamonds being sold in a set, with the display specifying that the diamonds sold came from the same rough diamond. The display is typically designed to attract the consumers to the diamond set, and to entice the consumers to buy the diamonds sold according to the system of this invention.

The system can be used for marketing of loose diamonds. The system can also be used marketing distinct pieces of jewelry having loose diamonds that came from one rough diamond. The system of this invention increases the appeal of diamonds and diamond jewelry to consumers by exerting a mental effect on consumers in offering a set of diamonds that were meant to be together by nature.

Many modifications and variations are possible in light of the above teachings. The foregoing is a description of the preferred embodiments of the invention and has been presented for the purpose of illustration and description. It is not intended to be exhaustive and so limit the invention to the precise form disclosed.

The invention is to be determined by the following claims:

1. A method of marketing diamonds, comprising the steps of:
cutting a single rough diamond, said cut creating at least two smaller diamonds;
providing said smaller diamonds for sale together in at least one set, each said set having at least two of said diamonds;
providing documentation with each said set, the documentation specifying that said diamonds came from a single rough diamond.

2. The method of claim 1, further comprising the step of packaging said set in at least one jewelry box.

3. The method of claim 1, further comprising the step of taking a photograph of said rough diamond prior to cutting the diamond, said photograph being included with said set.

4. The method of claim 2, further comprising the step of applying decorative matter onto said jewelry box.

5. The method of claim 2, further comprising the step of applying message-bearing indicia onto said jewelry box.

6. The method of claim 1, wherein said documentation is in the form of a booklet.

7. The method of claim 1, further comprising the step of positioning a display in close proximity to said set of smaller diamonds, said display capable of attracting attention of consumers to said set.

8. The method of claim 7, said display stating that the diamonds being sold in said set came from a single rough diamond.

9. The method of claim 1, further comprising the step of micro-engraving serial numbers on said smaller diamonds.

10. The method of claim 9, wherein said serial numbers are generated in such a way as to indicate that said smaller diamonds came from a single rough diamond.

11. The method of claim 1, further comprising the step of cutting said rough diamond into smaller diamonds such that said smaller diamonds have matching edges, said smaller diamonds being provided for sale together in a set.

12. The method of claim 1, further comprising the step of mounting said smaller diamonds into at least two distinct pieces of jewelry.

13. The method of claim 12, wherein said jewelry is rings.

14. A system for marketing diamonds comprising:
at least two diamonds, said diamonds coming from a single rough diamond and
documentation provided with said diamonds, the documentation specifying that said diamonds came from the same rough diamond.

15. The system of claim 14, wherein said documentation includes a photograph of said rough diamond.

16. The system of claim 15, further comprising a jewelry box, said jewelry box containing decorative matter thereon.

17. The system of claim 14, wherein said diamonds are mounted on at least two pieces of distinct jewelry.

18. The system of claim 17, wherein said jewelry is rings.

19. The system of claim 14, wherein a display is provided in close proximity to said diamonds, said display capable of attracting attention of consumers to said diamonds.

20. The system of claim 14, wherein said smaller diamonds provided in a set have matching edges.
